(19) United States
(12) Patent Application Publication
(10) Pub. No.: US 2004/0200438 A1
(43) Pub. Date: Oct. 14, 2004

(54) Pet waste pick up and carrying bag

(76) Inventor: Deborah Lee Jeffrey, Scotts Valley, CA (US)

Correspondence Address: John B. Dickman, III, Suite 1203, 2001 Jeff Davis Hwy., Arlington, VA, 22202, US

(21) Appl. No.: 10/409,183

(22) Filed: Apr. 9, 2003

(51) Int. Cl. A62B 35/00

(52) U.S. Cl. 119/858

(57) ABSTRACT

A pet pouch or bag having a cover flap for carrying empty plastic or other type of bags in a first compartment therein, and then selectively using said bags to pick up pet detritus from the ground and storing the filled bags in a second compartment until they can be deposited in a suitable waste container for collection by a commercial trash hauler.

A strap is provided on the bag so it can be carried by the animal or a person.

### FIELD OF THE INVENTION

The present invention relates to an apparatus for cleaning up after a pet, and in particular, to a pouch or bag for carrying plastic disposable bags used for collecting animal excrement and holding the filled disposable bag until it can be disposed of.

### BACKGROUND OF THE INVENTION

Many cities have found it necessary to enact ordinances to require pet owners to clean up after their pets. Prior to these ordinances, it was common to find pet owners did not clean up after their pets. Of course, there were exceptions that believed the responsibility of having a pet friend also included cleaning up after their pets.

The problem has gotten the attention of inventors, as for example, Knudson, U.S. Pat. No. 5,713,616, where a receptacle houses pet excrement and tools for clean up; and Rodriguez, U.S. Pat. No. 6,237,533 B1, where an apparatus houses clean up bags and a compartment for filled clean up bags.

### BRIEF DESCRIPTION OF THE DRAWINGS

FIG. 1 shows a plan view of a clean up bag of the invention;

FIG. 2 is a perspective view of the clean up bag of FIG. 1;

FIG. 3 is a view of a dog carrying a clean up bag around its neck;

FIG. 4 shows a filled bag being deposited in the clean up bag.

### DETAILED DESCRIPTION OF THE INVENTION

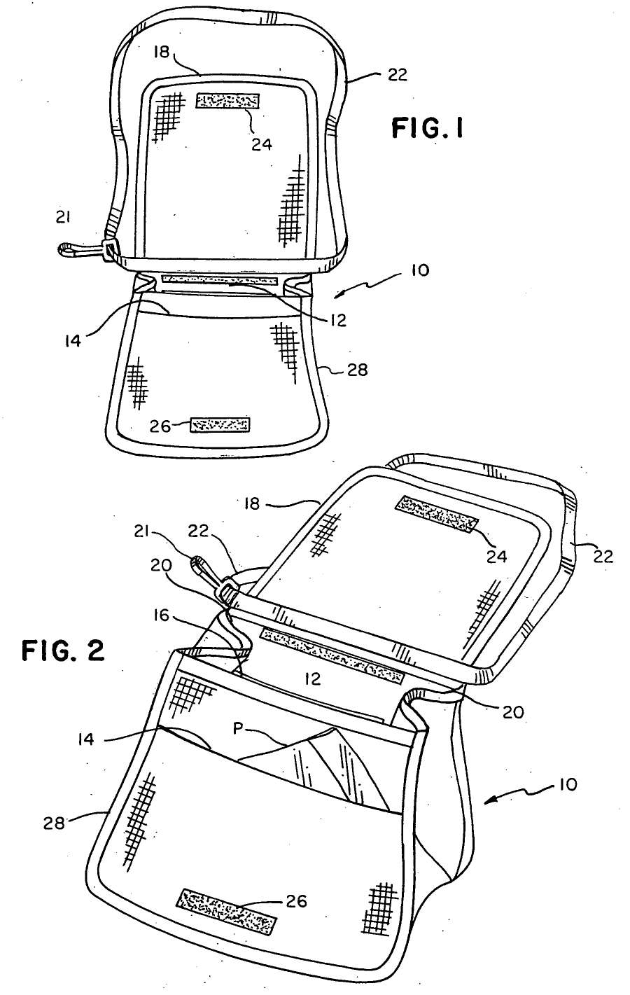

The invention is shown in FIG'S. 1-4. FIG. 2 shows a clean up bag 10 made of a fabric such as canvas, synthetics including polyesters, nylons, etc. The clean up bag 10 is made with a large compartment 12 for holding filled plastic bags P, partially shown in the outside compartment 14. The large compartment 12 has enough space for holding a number of filled bags.

The clean up bag 10 is constructed of four pieces of material; a wrap around piece provides front edge 16 of compartment 12 and a hinged flap 18 for covering compartment 12. Sewn or otherwise attached to the free edges of the wrap around piece is a second piece, which completes the top edge 20 of compartment 12. A third piece is sewn to the front of the compartment 12 forming outside compartment 14. A fourth piece is an insert for the bottom of the bag to join the front and back together.

A carrying strap 22, FIG'S. 1 and 2, is sewn or otherwise attached to the underside of hinged flap 18 so that the strap 22 supports the clean up bag 10, even if the strap should tear away from the hinged flap, once the flap 18 covers compartments 12 and 14 fasteners by a Velcro hook piece 24 on the underside of flap 18 attaching to loop piece 26 on compartment 14. A snap type hook 21 is attached to strap 22 as shown in FIGS. 1,2 and 4 and can be used to removeably fasten the pouch to the belt of the user if desired.

The ends of the three pieces of fabric that are sewn together may be covered by a trim fabric 28 to protect the edges from fraying.

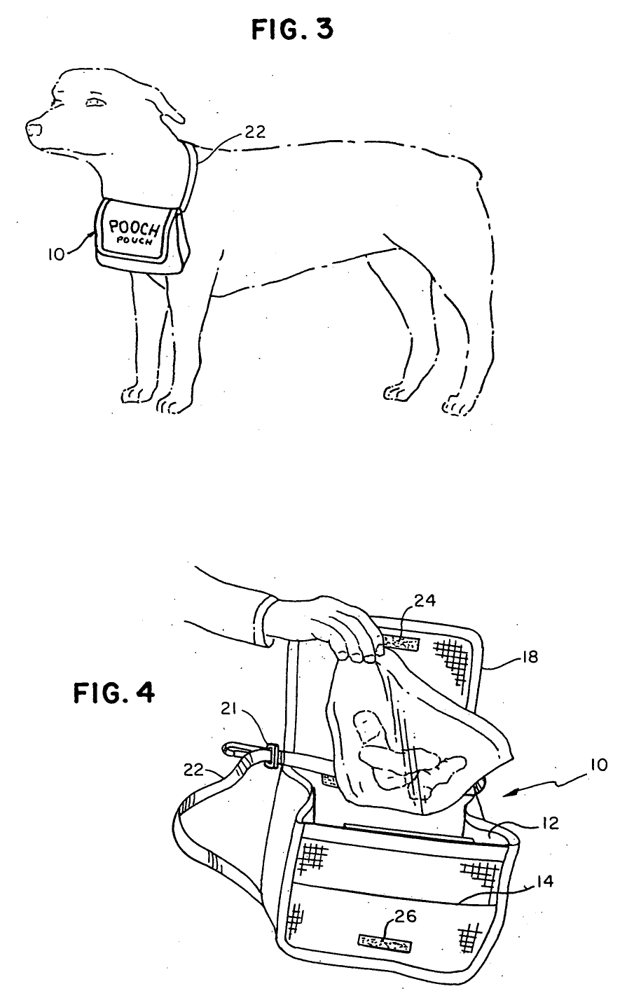

The cleanup bag is preferably hung over the owners shoulder or around the waist, but as shown in FIG. 3, the bag can be carried by a pet, the strap hung over the pet's neck. The clean up bag holds empty plastic bags, and when a dog has answered the call of nature, the excrement is cleaned up using a plastic bag, which is then deposited, in compartment 12, as shown in FIG. 4.

It is understood that while only one embodiment has been shown, others may be realized; therefore, one should consider the drawings, specification and claims for a complete understanding of the invention.

1-3 cancelled.

4. A clean up bag for pet supplies and p t excrement comprising first and second compartments, a hinged flap on said bag having hook and loop fastening means on the underside of the hinged portion of said flap and said flap adapted to cover said compartments when desired, and having separate hook and loop fasteners on said bag, a strap to carry said bag, said strap having hook and loop fastening means on said strap adapted to mate with the hook and loop means on the underside of the hinged portion of said flap, said strap being easily removed and replaced as desired, and when in place the bag can be carried by said strap by a person and alternately by looping the strap over a dog's head and neck, one of said compartments holding unused excrement bags, the other compartment holding filled bags of excrement, the hinged flap covering both compartments when the separate hook and loop fasteners on the bag and the separate hook and loop fasteners on the flap are engaged.
